(19) United States
(12) Patent Application Publication
(10) Pub. No.: US 2017/0068413 A1
(43) Pub. Date: Mar. 9, 2017

(54) PROVIDING AN INFORMATION SET RELATING TO A GRAPHICAL USER INTERFACE ELEMENT ON A GRAPHICAL USER INTERFACE

(71) Applicant: Microsoft Technology Licensing, LLC, Redmond, WA (US)

(72) Inventors: Martin Jansky, Espoo (FI); Apaar Tuli, Helsinki (FI); Erkko Anttila, Espoo (FI); Timo-Pekka Viljamaa, Helsinki (FI)

(21) Appl. No.: 14/848,616

(22) Filed: Sep. 9, 2015

(51) Int. Cl. G06F 3/0488; G06F 3/01; G06F 3/16; G06F 3/041

(52) U.S. Cl. CPC G06F 3/0488; G06F 3/0414; G06F 3/0416; G06F 3/016; G06F 3/167

(57) ABSTRACT

An apparatus is provided. The apparatus comprises at least one processing unit, at least one memory, a pressure level sensitive user input device and a graphical user interface. The at least one memory stores program instructions that, when executed by the at least one processing unit, cause the apparatus to detect that a pressure level applied on the pressure level sensitive user input device on a graphical user interface element of the graphical user interface exceeds a predetermined pressure level, provide an information set relating to the graphical user interface element on the graphical user interface while the applied pressure level exceeds the predetermined pressure level, detect that the applied pressure level becomes lower than the predetermined pressure level, and remove the information set from the graphical user interface.

### BACKGROUND

When using a touch-sensitive user interface, for example, a touch-sensitive display, a user is able to browse through content on the display via touch on the display. An object or a link may be selected by tapping the display on the location of the object or link. Some objects on the display may be links to a specific application or to elements in these applications. For example, when a new email message is received, the display may indicate with an icon to the user that a new email message has been received. It is also possible to show some additional information about the received email, for example, a title together with the sender information on the display when the email is received.

### SUMMARY

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one embodiment, an apparatus is provided. The apparatus comprises at least one processing unit, at least one memory, a pressure level sensitive user input device and a graphical user interface. The at least one memory stores program instructions that, when executed by the at least one processing unit, cause the apparatus to detect that a pressure level applied on the pressure level sensitive user input device on a graphical user interface element of the graphical user interface exceeds a predetermined pressure level, provide an information set relating to the graphical user interface element on the graphical user interface while the applied pressure level exceeds the predetermined pressure level, detect that the applied pressure level becomes lower than the predetermined pressure level, and remove the information set from the graphical user interface.

In another embodiment, a method is provided. The method comprises detecting that a pressure level applied on a pressure level sensitive user input device on a graphical user interface element of a graphical user interface exceeds a predetermined pressure level, providing an information set relating to the graphical user interface element on the graphical user interface while the applied pressure level exceeds the predetermined pressure level, detecting that the applied pressure level becomes lower than the predetermined pressure level, and removing the information set from the graphical user interface.

In another embodiment, an apparatus is provided. The apparatus comprises at least one processing unit, at least one memory and a touch and pressure level sensitive display element. The at least one memory stores program instructions that, when executed by the at least one processing unit, cause the apparatus to detect that a pressure level applied on a graphical user interface element on the touch and pressure level sensitive display element exceeds a predetermined pressure level, provide an information set relating to the graphical user interface element on the touch and pressure level sensitive display element while the applied pressure level exceeds the predetermined pressure level, detect that the applied pressure level becomes lower than the predetermined pressure level, and remove the information set from the touch and pressure level sensitive display element.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a system diagram depicting an apparatus including a variety of optional hardware and software components.

FIG. 2A illustrates an embodiment for providing information to a user with a graphical user interface.

FIG. 2B illustrates an embodiment for providing information to a user with a graphical user interface.

FIG. 2C illustrates an embodiment for providing information to a user with a graphical user interface.

FIG. 2D illustrates an embodiment for providing information to a user with a graphical user interface.

FIG. 2E illustrates an embodiment for providing information to a user with a graphical user interface.

FIG. 2F illustrates an embodiment for providing information to a user with a graphical user interface.

FIG. 3A illustrates an embodiment for providing additional information about one or more graphical user interface elements with an apparatus.

FIG. 3B illustrates an embodiment for providing additional information about one or more graphical user interface elements with an apparatus.

FIG. 3C illustrates an embodiment for providing additional information about a graphical user interface element with an apparatus.

FIG. 3D illustrates an embodiment for providing additional information about a graphical user interface element with an apparatus.

FIG. 3E illustrates an embodiment for providing additional information about one or more graphical user interface elements with an apparatus.

FIG. 3F illustrates an embodiment for selecting an information element.

FIG. 4A illustrates an embodiment for providing additional information about one or more graphical user interface element with an apparatus.

FIG. 4B illustrates an embodiment for providing additional information about one or more graphical user interface element with an apparatus.

FIG. 5A illustrates an embodiment for providing additional information about one or more graphical user interface element with an apparatus.

FIG. 5B illustrates an embodiment for providing additional information about one or more graphical user interface element with an apparatus.

FIG. 6A illustrates an embodiment for providing map related information to a user on a touch-sensitive display of an apparatus.

FIG. 6B illustrates an embodiment for providing map related information to a user on a touch-sensitive display of an apparatus.

FIG. 7A illustrates an embodiment for providing additional information about a graphical user interface element with an apparatus.

FIG. 7B illustrates an embodiment for providing additional information about a graphical user interface element with an apparatus.

FIG. 7C illustrates an embodiment for providing additional information about a graphical user interface element with an apparatus.

FIG. 8 discloses a flow diagram illustrating an embodiment of a method for providing additional information content relating to a graphical user interface element with an apparatus.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples. Furthermore, as used in this application and in the claims, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items.

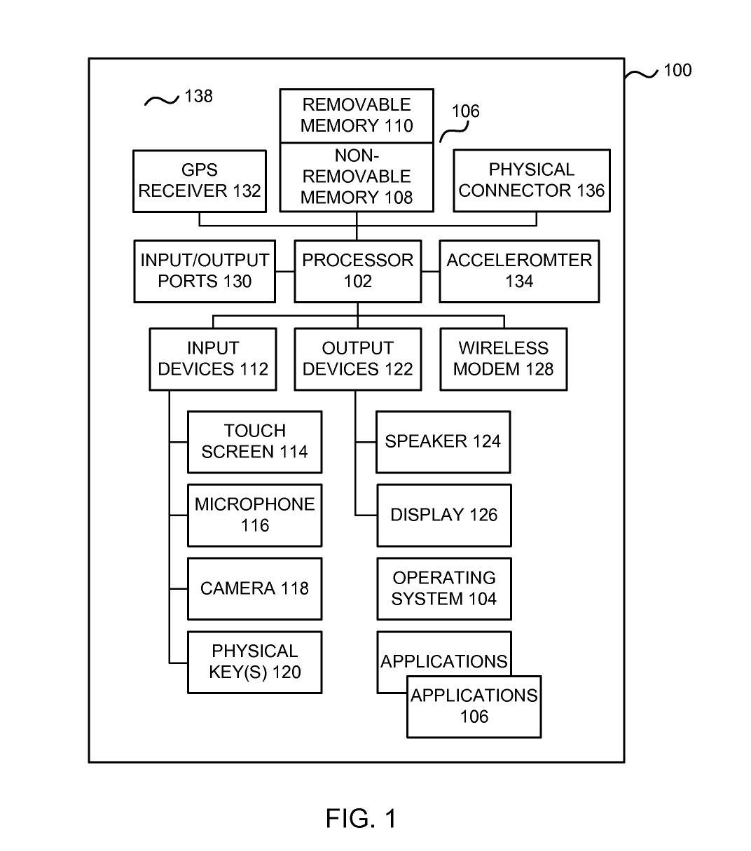

FIG. 1 is a system diagram depicting an apparatus 100 including a variety of optional hardware and software components, shown generally at 138. Any components 138 in the apparatus can communicate with any other component, although not all connections are shown, for ease of illustration. The apparatus can be any of a variety of computing devices (for example, a cell phone, a smartphone, a handheld computer, a tablet computer, a Personal Digital Assistant (PDA), etc.) and can allow wireless two-way communications with one or more communications networks, such as a cellular or satellite network.

The illustrated apparatus 100 can include a controller or processor 102 (e.g., signal processor, microprocessor, ASIC, or other control and processing logic circuitry) for performing such tasks as signal coding, data processing, input/output processing, power control, and/or other functions. An operating system 104 can control the allocation and usage of the components 138 and support for one or more application programs 106. The application programs can include common computing applications (e.g., email applications, calendars, contact managers, web browsers, messaging applications), or any other computing application.

The illustrated apparatus 100 can include a memory 106. The memory 106 can include non-removable memory 108 and/or removable memory 110. The non-removable memory 108 can include RAM, ROM, flash memory, a hard disk, or other well-known memory storage technologies. The removable memory 110 can include flash memory or a Subscriber Identity Module (SIM) card, which is well known in GSM communication systems, or other well-known memory storage technologies, such as “smart cards.” The memory 106 can be used for storing data and/or code for running the operating system 104 and the applications 106. Example data can include web pages, text, images, sound files, video data, or other data sets to be sent to and/or received from one or more network servers or other devices via one or more wired or wireless networks. The memory 106 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The apparatus 100 can support one or more input devices 112, such as a touchscreen 114, microphone 116, camera 118 and/or physical keys or a keyboard 120 and one or more output devices 122, such as a speaker 124 and a display 126. Other possible output devices (not shown) can include piezoelectric or other haptic output devices. Some devices can serve more than one input/output function. For example, the touchscreen 114 and the display 126 can be combined in a single input/output device. The input devices 112 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 104 or applications 106 can comprise speech-recognition software as part of a voice user interface that allows a user to operate the apparatus 100 via voice commands. Further, the apparatus 100 can comprise input devices and software that allows for user interaction via a user's spatial gestures, such as detecting and interpreting gestures to provide input to a gaming application.

A wireless modem 128 can be coupled to an antenna (not shown) and can support two-way communications between the processor 102 and external devices, as is well understood in the art. The modem 128 is shown generically and can include a cellular modem for communicating with a mobile communication network and/or other radio-based modems (e.g., Bluetooth or Wi-Fi). The wireless modem 128 is typically configured for communication with one or more cellular networks, such as a GSM network for data and voice communications within a single cellular network, a WCDMA (Wideband Code Division Multiple Access) network, an LTE (Long Term Evolution) network, a 4G LTE network, between cellular networks, or between the apparatus and a public switched telephone network (PSTN) etc.

The apparatus 100 can further include at least one input/output port 130, a satellite navigation system receiver 132, such as a Global Positioning System (GPS) receiver, an accelerometer 134, and/or a physical connector 136, which can be a USB port, IEEE 1394 (FireWire) port, and/or RS-232 port. The illustrated components 138 are not required or all-inclusive, as any components can deleted and other components can be added.

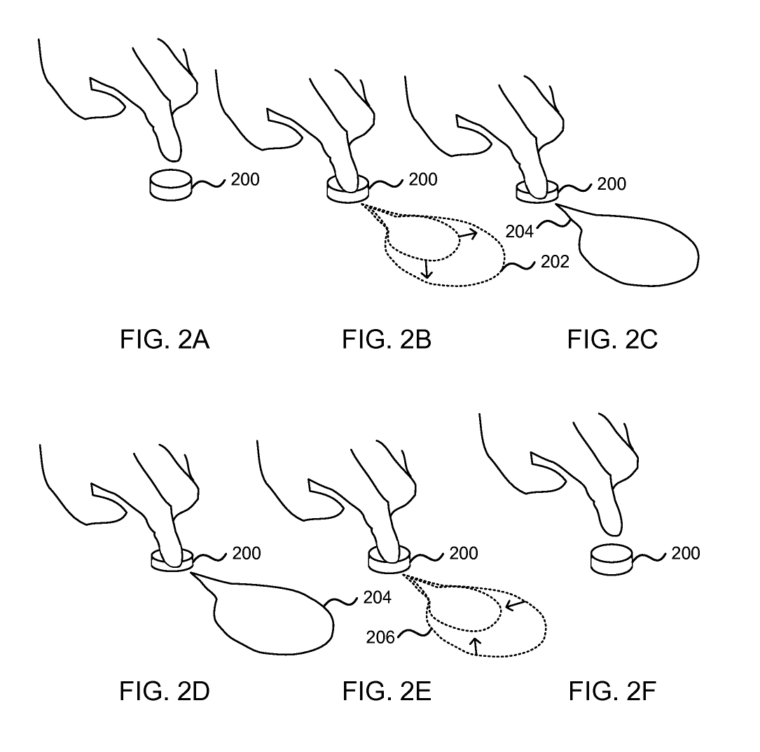

FIGS. 2A-2F illustrate an embodiment for providing information to a user with a graphical user interface of an apparatus. An element 200 is any graphical user interface element on the graphical user interface that provides information to the user and/or can be selected by the user, for example, with a finger, multiple fingers or a stylus. FIGS. 2A-2F illustrate the embodiment using a pressure level and touch sensitive display as an example of the graphical user interface. Instead of the pressure level and touch sensitive display, it is possible to use a separate pressure level sensitive user input device for detecting the user's touch and a separate display device to display the user's actions.

When the user starts to apply, for example, with a finger, multiple fingers or a stylus, pressure on the touch-sensitive display on the graphical user interface element 200, the pressure level of the touch is detected. If the pressure level applied on the touch-sensitive display exceeds a predetermined pressure level, an information set 204 relating to the graphical user interface element is provided on the touch-sensitive display, as indicated by FIG. 2C. The information set 204 provides some additional information about the graphical user interface element 200. As illustrated in FIG. 2B, it is also possible to visually animate the process of providing the information set 204 on the touch-sensitive display. Alternatively or in addition, at least one of audio or haptic feedback may be provided to the user when providing the information set 204 on the touch-sensitive display. When providing feedback to the user (visual, audio and/or haptic) the user is able to detect when the predetermined pressure level has been reached and thus also knows which pressure level needs to be maintained in order to keep the information set visible on the touch-sensitive display. The information set 204 may first be transparent and gradually become completely visible while at the same time the size of the information set 204 gradually increases to its full size, as indicated by a reference 202.

The predetermined pressure level is greater than a pressure level associated with a normal touch on the touch-sensitive display when the user operates the apparatus. The predetermined pressure level may be user-configurable or alternatively the predetermined pressure level may be automatically determined by the apparatus. For example, the apparatus may store historical data about the pressure levels used by the user when the user interacts with the touch-sensitive display. This provides information about the pressure level that the user normally uses when interacting with the touch-sensitive display.

The information set 204 is provided to the user on the touch-sensitive display as long as the pressure level on the touch-sensitive display exceeds the predetermined pressure level. When apparatus detects that the pressure level applied on the graphical user interface element 200 becomes lower than the predetermined pressure level, the information set 204 is removed from the touch-sensitive display, as indicated by FIGS. 2D and 2F. In one embodiment, the information set 204 is removed from the touch-sensitive display only when the user does not touch the touch-sensitive display any more.

By enabling the user to control how information is displayed on the graphical user interface as long as the pressure on the touch-sensitive display exceeds the predetermine pressure level, the user is able to get additional graphical user interface element related information intuitively, easily and quickly. This also makes the use of the graphical user interface more efficient.

As illustrated in FIG. 2E, it is also possible to visually animate the process of removing the information set 204 from the touch-sensitive display. Alternatively or in addition, at least one of audio or haptic feedback may be provided to the user when removing the information set 204 from the touch-sensitive display. The information set 204 may gradually become transparent while at the same time the size of the information set 204 gradually decreases, as indicated by a reference 206.

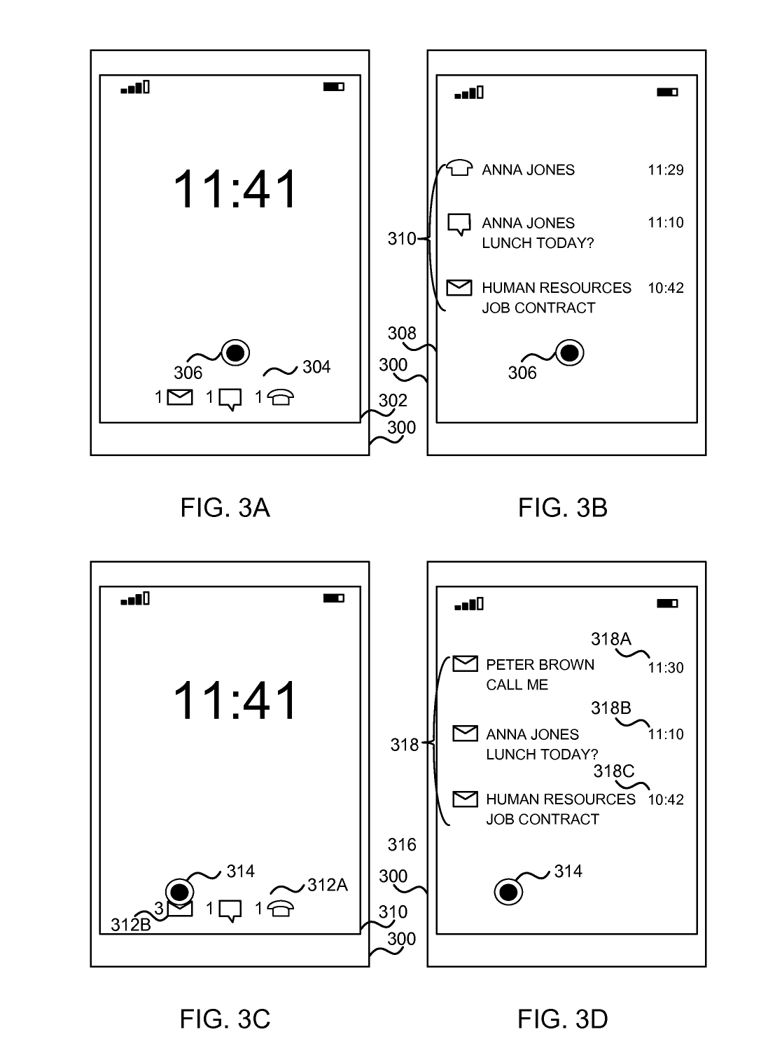

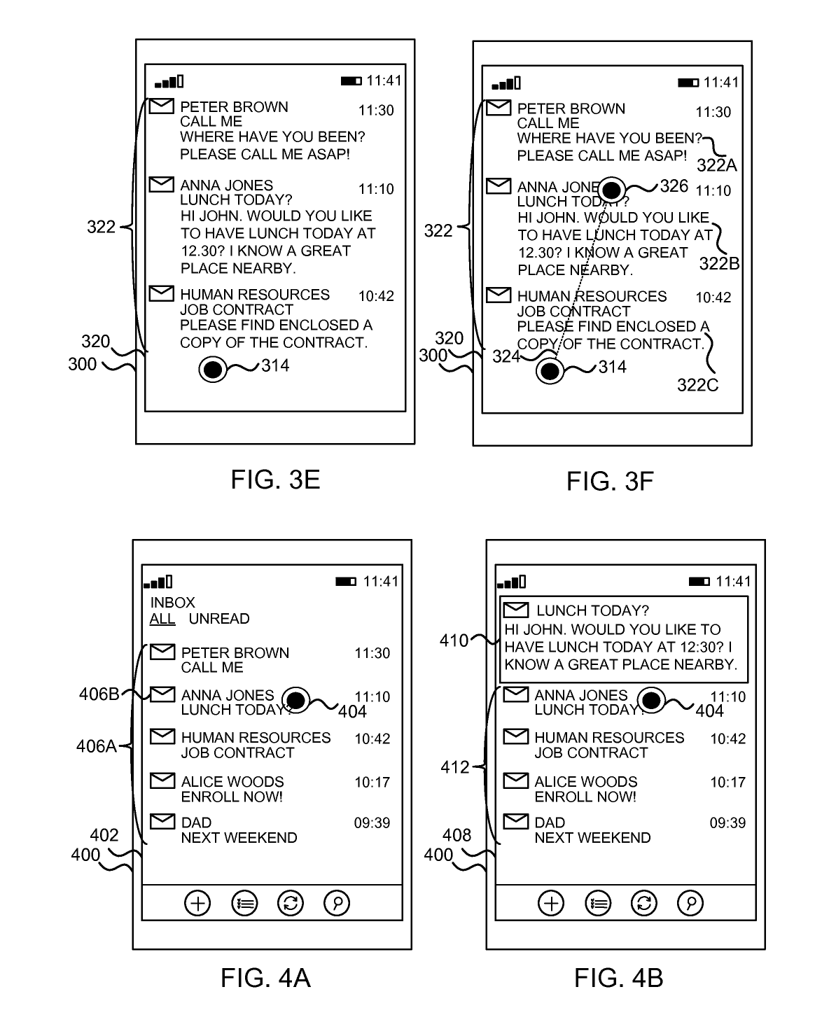

FIGS. 3A and 3B illustrate an embodiment for providing additional information about one or more graphical user interface elements with an apparatus 300. FIGS. 3A and 3B illustrate the embodiment using a pressure level and touch sensitive display as an example of the graphical user interface. Instead of the pressure level and touch sensitive display, it is possible to use a separate pressure level sensitive user input device for detecting the user's touch and a separate display device to display the user's actions.

A view 302 may be, for example, a standby view or a lock screen view on a touch-sensitive display of a mobile apparatus. The view 302 provides information icons 304 that indicate to the user that the apparatus 300 has recorded some received actions. In the embodiment of FIG. 3A, three information icons are provided. The first one indicates that one new email has been received, the second one indicates that one new text message has been received, and the third one indicates that there is one unanswered phone call.

When the user applies 306, for example, with a finger, multiple fingers or a stylus, on the touch-sensitive display a pressure level that exceeds a predetermined pressure level, the apparatus 300 interprets this as a command to display additional information relating to the information icons 304. FIG. 3B illustrates a view 308 provided by the touch-sensitive display when the user applies on the touch-sensitive display a pressure level that exceeds a predetermined pressure level. An information set 310 relating to the information icons 304 is provided on the touch-sensitive display. The information set 310 provides a preview relating to each information icon. Regarding the phone call, the calling time and the caller identity may be displayed. Regarding the received text and email messages, the time of receipt, the sender information and some message content may be displayed.

The information set 310 is provided to the user on the touch-sensitive display as long as the pressure level on the touch-sensitive display exceeds the predetermined pressure level. When apparatus 300 detects that the applied pressure level becomes lower than the predetermined pressure level, the information set 310 is removed from the touch-sensitive display, and the view 302 may again be shown to the user. In one embodiment, the information set 310 is removed from the touch-sensitive display only when the user does not touch the graphical user interface element on the touch-sensitive display any more.

FIGS. 3C and 3D illustrate an embodiment for providing additional information about a graphical user interface element with an apparatus 300. FIGS. 3C and 3D illustrate the embodiment using a pressure level and touch sensitive display as an example of the graphical user interface. Instead of the pressure level and touch sensitive display, it is possible to use a separate pressure level sensitive user input device for detecting the user's touch and a separate display device to display the user's actions.

A view 310 may be a standby view and a glance screen view on a touch-sensitive display of a mobile apparatus. The view 310 provides information icons 312A that indicate to the user that the apparatus 300 has recorded some received actions. In the embodiment of FIG. 3C, three information icons are provided. The first one indicates that three new emails have been received, the second one indicates that one new text message has been received, and the third one indicates that there is one unanswered phone call.

When the user applies 314, for example, with a finger, multiple fingers or a stylus, on the touch-sensitive display on an information icon 312B relating to the received new emails a pressure level that exceeds a predetermined first pressure level, the apparatus 300 interprets this as a command to display additional information relating to the information icon 312B. FIG. 3D illustrates a view 316 provided by the touch-sensitive display when the user applies on the touch-sensitive display on the information icon 312B a pressure level that exceeds the predetermined first pressure level. An information set 318 comprising three emails 318A, 318B, 318C relating to the information icon 312B is provided on the touch-sensitive display. The information set 318 provides a preview relating to the received new emails. The information set 318 includes the time of receipt of the emails, the sender information and the titles of the emails.

The information set 318 is provided to the user on the touch-sensitive display as long as the applied pressure level on the touch-sensitive display exceeds the predetermined first pressure level. When the apparatus 300 detects that the applied pressure level becomes lower than the predetermined first pressure level, the information set 318 is removed from the touch-sensitive display, and the view 310 may again be shown to the user. In one embodiment, the information set 318 is removed from the touch-sensitive display only when the user does not touch the graphical user interface element on the touch-sensitive display any more.

FIG. 3E illustrates an embodiment for providing additional information about one or more graphical user interface elements with an apparatus 300. A view 320 illustrated in FIG. 3E is provided to the user when the apparatus 300 detects that the pressure level applied 314, for example, with a finger, multiple fingers or a stylus, on the touch-sensitive display exceeds a predetermined second pressure level, the predetermined second pressure level exceeding the predetermined first pressure level. An information set 322 now comprises more detailed information about the received new emails than the information set 318. The amount of information is extended in the information set 322. If the amount of content in the body field of an email is low, the information set 322 may be able to show the whole message content of such an email, like in the case of emails 322A and 322B. The email 322C comprises a longer body field, and only the first sentence of the body field is shown in the information set 322.

The information set 322 is provided to the user on the touch-sensitive display as long as the applied pressure level on the touch-sensitive display exceeds the predetermined second pressure level. When the apparatus 300 detects that the applied pressure level becomes lower than the predetermined first and second pressure levels, the information set 322 is removed from the touch-sensitive display, and the view 310 may again be shown to the user. In one embodiment, the information set 322 is removed from the touch-sensitive display only when the user does not touch the graphical user interface element on the touch-sensitive display any more.

In at least one of the embodiments of FIGS. 3A-3E, when the user is able to receive further information by applying a predetermined amount of pressure on a screen comprising one or more information icons, the user is able to easily and quickly access additional information relating to the icons. This makes the use of the graphical user interface more efficient. For example, if an information icon illustrates new unread email messages, the user is able to access the email content without launching an email application. Further, by enabling detection of multiple predetermined pressure levels it is possible to provide multiple information content levels to the user without the need to launch dedicated applications to view the same information. This also makes the use of the graphical user interface more efficient.

Further, although FIGS. 3A-3E illustrate the use of two or more predetermined pressure levels, in another embodiment the amount of information provided in the information set may be proportional to the pressure level applied on the touch-sensitive display. The term “proportional” may mean stepwise or step less dependency between the amount of information provided in the information set and the pressure level applied on the touch-sensitive display. For example, when the applied pressure level on the touch-sensitive display exceeds the predetermined first pressure level and the pressure level still increases, the amount of information provided in the information set may continuously increase as long as the pressure level increases. This can be used, for example, when providing map data to the user. The user is able to easily and intuitively control the amount of information in the information set.

FIG. 3F illustrates an embodiment continuing the embodiment illustrated in FIG. 3E. After providing the information set 322 to the user, it is possible for the user to select one of the emails 322A, 322B, 322C. In order to select one of the emails, the user may first release the pressure application on the touch-sensitive display as long as the user keeps his finger, multiple fingers or a stylus in touch with the touch-sensitive display. The user may then slide (illustrated with a dashed line 324) his finger or the stylus on the touch-sensitive display and stop on one of the emails. In order to select the email 322B and open the email 322B in an email application, the user again applies 326 a pressure level that exceeds a predetermined pressure level. The predetermined pressure level may be the previously mentioned first or second pressure level or a different pressure level. In response to detecting the predetermined pressure level, the apparatus 300 causes an email application to be opened and displays the email 322B in the email application.

FIGS. 4A and 4B illustrate an embodiment for providing additional information about one or more graphical user interface elements with an apparatus 400. FIGS. 4A and 4B illustrate the embodiment using a pressure level and touch sensitive display as an example of the graphical user interface. Instead of the pressure level and touch sensitive display, it is possible to use a separate pressure level sensitive user input device for detecting the user's touch and a separate display device to display the user's actions.

When the user browses his emails using an email application running in the apparatus 400, a view 402 listing several received emails 406A may be provided to the user. When the user applies 404, for example, with a finger, multiple fingers or a stylus, on a desired email 406B on the touch-sensitive display a pressure level that exceeds a predetermined pressure level, the apparatus 400 interprets this as a command to display additional information relating to the selected email 406B.

FIG. 4B a view 408 provided by the touch-sensitive display when the user applies on the touch-sensitive display on the email 406B a pressure level that exceeds the predetermined pressure level. A preview window 410 is shown in the view 408 showing the whole content of the email 406B or at least some additional content contained in the email 406B. In the embodiment disclosed in FIG. 4B, the email 406B is short and the preview window 410 is able to show the whole email content.

The preview window 410 is provided to the user on the touch-sensitive display as long as the pressure level applied on the touch-sensitive display by the user exceeds the predetermined pressure level. In another embodiment, the preview window 410 is provided to the user on the touch-sensitive display as long as the user applies some pressure on the touch-sensitive display. When apparatus 400 detects that the applied pressure level becomes lower than the predetermined pressure level or becomes zero, the preview window 410 is removed from the touch-sensitive display, and the view 402 may again be shown to the user. In one embodiment, the preview window 410 is removed from the touch-sensitive display only when the user does not touch the graphical user interface element on the touch-sensitive display any more.

When the user is able to get preview information relating to a message by applying a predetermined amount of pressure on a graphical user interface comprising one or more messages, the user is able to easily and quickly access additional information relating to the messages. This makes the use of the graphical user interface more efficient.

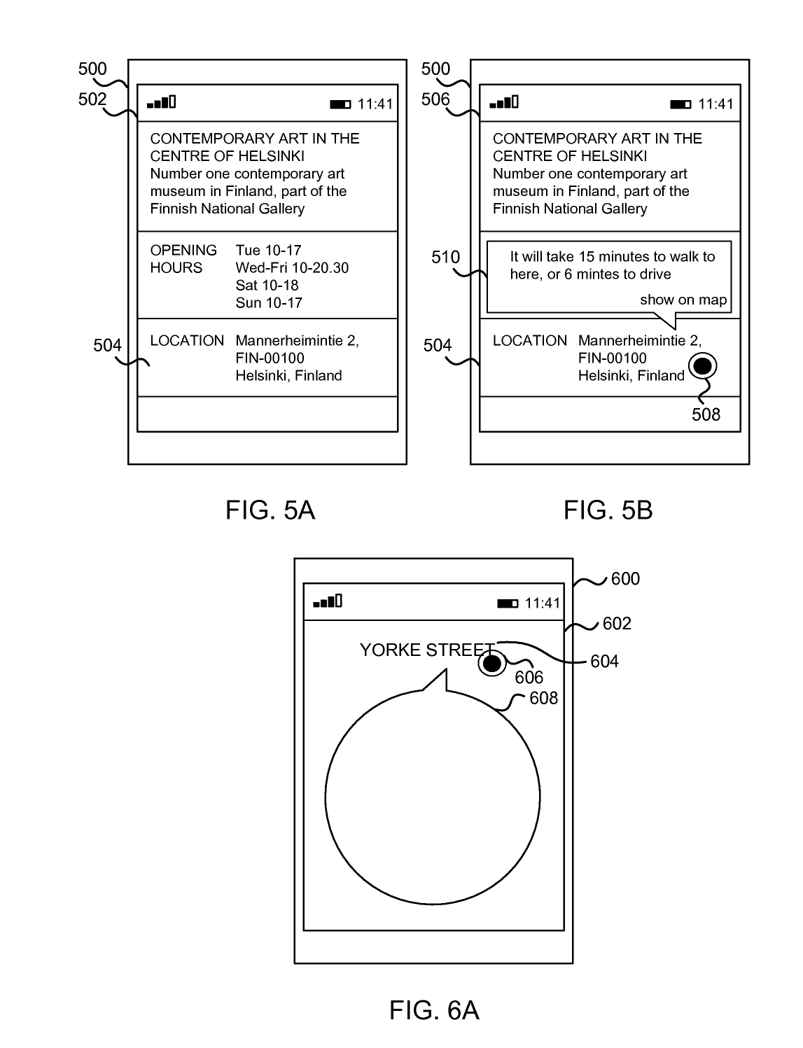

FIGS. 5A and 5B illustrate an embodiment for providing additional information about one or more graphical user interface elements with an apparatus 500. FIGS. 5A and 5B illustrate the embodiment using a pressure level and touch sensitive display as an example of the graphical user interface. Instead of the pressure level and touch sensitive display, it is possible to use a separate pressure level sensitive user input device for detecting the user's touch and a separate display device to display the user's actions.

A view 502 provides a web page displayed on the touch-sensitive display of the apparatus 500. The web page provides information about an art museum. A section 504 on the web page provides location information relating to the art museum. FIG. 5B illustrates a view 506 provided by the touch-sensitive display when the user applies 508, for example, with a finger, multiple fingers or a stylus, on the touch-sensitive display on the section 504 a pressure level that exceeds a predetermined pressure level. An additional information window 510 is provided to the user, the information window 510 providing transportation information to the art museum. The information in the additional information window may be downloaded, for example, from the internet or a cloud service in response to detecting that the user applies on the touch-sensitive display on the section the pressure level that exceeds the predetermined pressure level.

When the user starts applying the pressure level exceeding the predetermined pressure level on the touch-sensitive display, as illustrated by reference 508, the apparatus 500 may determine the geographical location of the user. The apparatus 500 may also be capable of recognizing that the web page section 504 includes address information. Once the geographical location of the user is known and the address in the web page section 504 has been recognized, the apparatus 500 is able to provide the additional information window on the touch-sensitive display.

The preview window 510 is provided to the user on the touch-sensitive display as long as the pressure level applied on the touch-sensitive display by the user exceeds the predetermined pressure level. When apparatus 500 detects that the applied pressure level becomes lower than the predetermined pressure level or becomes zero, the preview window 510 is removed from the touch-sensitive display, and the view 502 may again be shown to the user.

When the user is able to get additional information relating to a graphical user interface element by applying a predetermined amount of pressure on the graphical user interface element, the user is able to easily and quickly access additional information relating to the graphical user interface element. This makes the use of the graphical user interface more efficient.

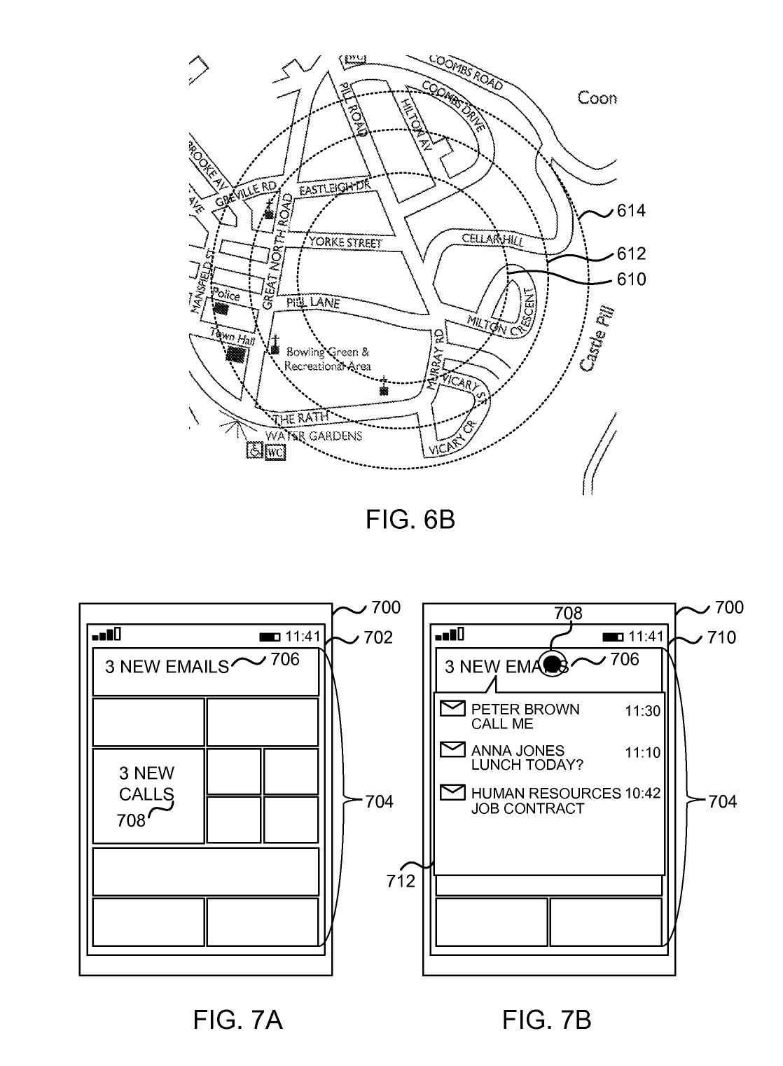

FIGS. 6A and 6B illustrate an embodiment for providing map related information to a user on a touch-sensitive display of an apparatus 600. FIGS. 6A and 6B illustrate the embodiment using a pressure level and touch sensitive display as an example of the graphical user interface. Instead of the pressure level and touch sensitive display, it is possible to use a separate pressure level sensitive user input device for detecting the user's touch and a separate display device to display the user's actions.

A view 602 displayed on the touch-sensitive display provides a graphical user interface element 604. The graphical user interface element 604 may be provided to the user, for example, on a web page. The graphical user interface element 604 may comprise a link, for example, a web page link. Alternatively, the graphical user interface element 604 may be a static element.

In FIG. 6A, the graphical user interface element 604 includes a street address. The apparatus 600 may be able to deduce that the graphical user interface element 604 comprises a street address. When the user applies 606, for example, with a finger, multiple fingers or a stylus on the graphical user interface element 604 a pressure level that exceeds a predetermined pressure level, the apparatus 600 interprets this as a command to display additional information relating to the graphical user interface element 604. Alternatively, the graphical user interface element 604 may also comprise a link to map data.

In response to detecting the pressure level exceeding the predetermined pressure level, the apparatus provides on the touch-sensitive display an information window 608 providing the map data relating to the graphical user interface element 604. FIG. 6B illustrates an example of map data that may be provided to the user in the information window 608. In this embodiment, the information window 608 is a circular window configured to display map data content illustrated in FIG. 6B. Circles 610, 612, 614 in FIG. 6B illustrate different amounts of the map content that may be displayed in the information window 608. In this embodiment, three different pressure levels may have been predetermined. A predetermined first pressure level (L1) associates to the map data enclosed by the circle 610, a predetermined second pressure level (L2) associates to the map data enclosed by the circle 612, and a predetermined third pressure level (L3) associates to the map data enclosed by the circle 614, wherein L1<L2<L3.

When the user applies 606 on the graphical user interface element 604 a pressure level that exceeds the first pressure level, the information window 608 is configured to display the map data enclosed by the circle 610. When the user increases the pressure level on the touch-sensitive display and the pressure level exceeds the second pressure level, the information window 608 is configured to display the map data enclosed by the circle 612. Similarly, when the user increases the pressure level on the touch-sensitive display and the pressure level exceeds the third pressure level, the information window 608 is configured to display the map data enclosed by the circle 614. By alternating the pressure level on the touch-sensitive display, the user is able to control the information content in the information window 608.

The information window 608 is provided to the user on the touch-sensitive display as long as the pressure level on the touch-sensitive display exceeds the predetermined first pressure level. When apparatus 600 detects that the applied pressure level becomes lower than the predetermined first pressure level, the information window 608 is removed from the touch-sensitive display. In one embodiment, the information window 608 is removed from the touch-sensitive display only when the user does not touch the graphical user interface element on the touch-sensitive display any more.

When the user is able to get additional information relating to a graphical user interface element by applying a predetermined amount of pressure on the graphical user interface element, the user is able to easily and quickly access additional information relating to the graphical user interface element. Further, the user does not have to separately initiate new windows or applications, for example, a map window or application, in order to be able to access the additional information. This makes the use of the graphical user interface more efficient.

In another embodiment of FIGS. 6A and 6B, the graphical user interface element 604 on the view 602 may enable the user to request map data of his current location. The graphical user interface element may, for example, state “show my location”. When the user applies on this graphical user interface element a pressure level that exceeds a predetermined pressure level, the apparatus interprets this as a command to display map data of the current location of the user.

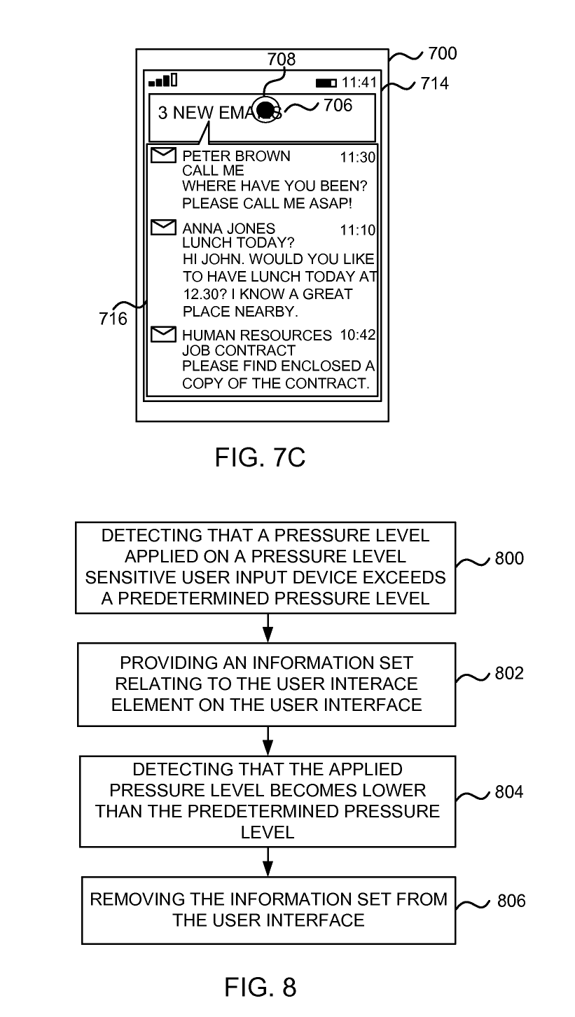

FIG. 7A illustrates a view 702 on a display of an apparatus 700. The apparatus 700 is, for example, a mobile apparatus (a smart phone, a tablet computer etc.). The view 702 comprises a set of tiles 704, each tile representing different applications and enabling different applications to be launched. One or more of the tiles 704 may also display some application-specific information relating to the respective tile. In this embodiment, a tile 706 indicates that three new email messages have been received and a tile 708 indicates that there are three new unanswered calls.

Normally, if a user wanted to check the new emails in more detail, he would have to tap the tile 706 and an email application would be launched in response to the tap. FIG. 7B, a view 710 shown on the display of the apparatus 700 when the user applies 708, for example, with a finger, multiple fingers or a stylus, on the tile 706 a pressure level that exceeds a predetermined pressure level. An additional information window 712 is shown to the user providing additional information on the received three new emails. If the user is satisfied with this level of information, he may close the information window 712 by removing his finger from the display.

FIG. 7C illustrates a view 714 on the display of the apparatus 700 if the pressure level applied 708 by the user exceeds a second predetermined pressure level, the predetermined second pressure level exceeding the predetermined first pressure level. An information set 716 now comprises more detailed information about the received new emails than the information set 712. The amount of information is extended in the information set 716. If the amount of content in the body field of an email is low, the information set 716 may be able to show the whole message content of such an email.

The information set 716 may be provided to the user on the display as long as the applied pressure level on the touch-sensitive display exceeds the predetermined second pressure level. When the apparatus 700 detects that the applied pressure level becomes lower than the predetermined first and second pressure levels, the information set 716 is removed from the display, and the view 702 may again be shown to the user. In one embodiment, the information set 716 is removed from the display only when the user does not apply any pressure on the display any more.

The embodiments disclosed in FIGS. 7A, 7B and 7C enable the detection of one or more predetermined pressure levels making it possible to provide multiple information content levels to the user without the need to launch dedicated applications, for example, an email application to view the same information. This also saves the user's time since the same information is quickly available just by touching the display with a correct amount of pressure, thus making the use of the graphical user interface more efficient.

FIG. 8 discloses a flow diagram illustrating an embodiment of a method for providing additional information content relating to a graphical user interface element with an apparatus.

In 800 it is detected that a pressure level applied, for example, with a finger, multiple fingers or a stylus, on the pressure level sensitive user input device on the graphical user interface element on the graphical user interface exceeds a predetermined pressure level. The graphical user interface and the pressure level sensitive user input device may be provided by a single element, for example, a pressure level and touch sensitive display, or by separate apparatus elements.

In 802 an information set relating to the graphical user interface element is provided on the graphical user interface while the applied pressure level exceeds the predetermined pressure level.

In 804 it is detected that the pressure level applied on the graphical user interface element becomes lower than the predetermined pressure level. The user may lighten the pressure level applied on the graphical user interface so that pressure is still applied on the graphical user interface but the pressure level is lower than the predetermined pressure level. Alternatively, the user may completely release the touch on the graphical user interface.

In 806 the information set is removed from the graphical user interface.

At least some of the embodiments provide one more of the following effects. A solution is provided that enables more efficient use of a graphical user interface and leads also to improved user-experience. The user need not launch any dedicated applications in order to be able to view additional information relating to at least one graphical user interface element. By enabling the user to control how information is displayed on the graphical user interface as long as the pressure on the graphical user interface exceeds a predetermine pressure level, the user is able to get additional graphical user interface element related information intuitively, easily and quickly.

According to an aspect, there is provided an apparatus comprising at least one processing unit, at least one memory, a pressure level sensitive user input device and a graphical user interface, The at least one memory stores program instructions that, when executed by the at least one processing unit, cause the apparatus to detect that a pressure level applied on the pressure level sensitive user input device on a graphical user interface element of the graphical user interface exceeds a predetermined pressure level, provide an information set relating to the graphical user interface element on the graphical user interface while the applied pressure level exceeds the predetermined pressure level, detect that the applied pressure level becomes lower than the predetermined pressure level, and remove the information set from the graphical user interface.

In one embodiment, the at least one memory stores program instructions that, when executed by the at least one processing unit, cause the apparatus to detect that the pressure level applied on the pressure level sensitive user input device on the graphical user interface element on the graphical user interface exceeds a predetermined second pressure level, the predetermined second pressure level exceeding the predetermined first pressure level, and extend the amount of information in the information set.

In one embodiment, alternatively or in addition, the amount of information provided in the information set is proportional to the pressure level applied on the pressure level sensitive user input device.

In one embodiment, alternatively or in addition, the at least one memory stores program instructions that, when executed by the at least one processing unit, cause the apparatus to provide at least one of visual, audio or haptic feedback when providing the information set relating to the graphical user interface element on the graphical user interface.

In one embodiment, alternatively or in addition, the at least one memory stores program instructions that, when executed by the at least one processing unit, cause the apparatus to provide at least one of visual, audio or haptic feedback when removing the information set from the graphical user interface.

In one embodiment, alternatively or in addition, the at least one memory stores program instructions that, when executed by the at least one processing unit, cause the apparatus to remove the information set from the graphical user interface when detecting that the applied pressure level becomes zero.

In one embodiment, alternatively or in addition, the graphical user interface element comprises at least one information icon indicating at least one new event detected by the apparatus.

In one embodiment, alternatively or in addition, the graphical user interface element comprises a message provided by a messaging application.

In one embodiment, alternatively or in addition, the information set comprises map data. In one embodiment, the amount of map data provided in the information set is proportional to the pressure level applied on the pressure level sensitive user input device.

According to an aspect, there is provided a method comprising detecting that a pressure level applied on a pressure level sensitive user input device on a graphical user interface element of a graphical user interface exceeds a predetermined pressure level, providing an information set relating to the graphical user interface element on the graphical user interface while the applied pressure level exceeds the predetermined pressure level, detecting that the applied pressure level becomes lower than the predetermined pressure level, and removing the information set from the graphical user interface.

In one embodiment, the method comprises detecting that the pressure level applied on the pressure level sensitive user input device on the graphical user interface element on the graphical user interface exceeds a predetermined second pressure level, the predetermined second pressure level exceeding the predetermined first pressure level, and extending the amount of information in the information set.

In one embodiment, alternatively or in addition, the amount of information provided in the information set is proportional to the pressure level applied on the pressure level sensitive user input device.

In one embodiment, alternatively or in addition the method comprises providing at least one of visual, audio or haptic feedback when providing the information set relating to the graphical user interface element on the graphical user interface.

In one embodiment, alternatively or in addition, the method comprises providing at least one of visual, audio or haptic feedback when removing the information set from the graphical user interface.

In one embodiment, alternatively or in addition, the method comprises removing the information set from the graphical user interface when detecting that the applied pressure level becomes zero.

In one embodiment, alternatively or in addition, the graphical user interface element comprises at least one information icon indicating at least one new event detected by the apparatus.

In one embodiment, alternatively or in addition, the graphical user interface element comprises a message provided by a messaging application.

In one embodiment, alternatively or in addition, the information set comprises map data. In one embodiment, the amount of map data provided in the information set is proportional to the pressure level applied on the pressure level sensitive user input device.

According to another aspect, there is provided an apparatus comprising at least one processing unit, at least one memory, a touch and pressure level sensitive display element. The at least one memory stores program instructions that, when executed by the at least one processing unit, cause the apparatus to detect that a pressure level applied on a graphical user interface element on the touch and pressure level sensitive display element exceeds a predetermined pressure level, provide an information set relating to the graphical user interface element on the touch and pressure level sensitive display element while the applied pressure level exceeds the predetermined pressure level, detect that the applied pressure level becomes lower than the predetermined pressure level, and remove the information set from the touch and pressure level sensitive display element.

According to another aspect, there is provided an apparatus comprising a pressure level sensitive user input device, a graphical user interface, means for detecting that a pressure level applied on the pressure level sensitive user input device on a graphical user interface element of the graphical user interface exceeds a predetermined pressure level, means for providing an information set relating to the graphical user interface element on the graphical user interface while the applied pressure level exceeds the predetermined pressure level, means for detecting that the applied pressure level becomes lower than the predetermined pressure level, and means for removing the information set from the graphical user interface.

According to another aspect, there is provided an apparatus comprising a touch and pressure level sensitive display element, means for detecting that a pressure level applied on a graphical user interface element on the touch and pressure level sensitive display element exceeds a predetermined pressure level, means for providing an information set relating to the graphical user interface element on the touch and pressure level sensitive display element while the applied pressure level exceeds the predetermined pressure level, means for detecting that the applied pressure level becomes lower than the predetermined pressure level, and means for removing the information set from the touch and pressure level sensitive display element.

According to another aspect, there is provided a computer program comprising program code, which when executed by at least one processor, causes an apparatus to perform detecting that a pressure level applied on a pressure level sensitive user input device on a graphical user interface element of a graphical user interface exceeds a predetermined pressure level, providing an information set relating to the graphical user interface element on the graphical user interface while the applied pressure level exceeds the predetermined pressure level, detecting that the applied pressure level becomes lower than the predetermined pressure level, and removing the information set from the graphical user interface.

In one embodiment, the computer program is embodied on a computer-readable medium.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The functions described herein performed by a controller may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Although the subject matter may have been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages.

Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. An apparatus, comprising:
at least one processing unit;
at least one memory;
a pressure level sensitive user input device;
a graphical user interface;
wherein the at least one memory stores program instructions that, when executed by the at least one processing unit, cause the apparatus to:
detect that a pressure level applied on the pressure level sensitive user input device on a graphical user interface element of the graphical user interface exceeds a predetermined pressure level;
provide an information set relating to the graphical user interface element on the graphical user interface while the applied pressure level exceeds the predetermined pressure level;
detect that the applied pressure level becomes lower than the predetermined pressure level; and
remove the information set from the graphical user interface.

2. An apparatus according to claim 1, wherein the at least one memory stores program instructions that, when executed by the at least one processing unit, cause the apparatus to:
detect that the pressure level applied on the pressure level sensitive user input device on the graphical user interface element on the graphical user interface exceeds a predetermined second pressure level, the predetermined second pressure level exceeding the predetermined first pressure level; and
extend the amount of information in the information set.

3. An apparatus according to claim 1, wherein the amount of information provided in the information set is proportional to the pressure level applied on the pressure level sensitive user input device.

4. An apparatus according to claim 1, wherein the at least one memory stores program instructions that, when executed by the at least one processing unit, cause the apparatus to:
provide at least one of visual, audio or haptic feedback when providing the information set relating to the graphical user interface element on the graphical user interface.

5. An apparatus according to claim 1, wherein the at least one memory stores program instructions that, when executed by the at least one processing unit, cause the apparatus to:
provide at least one of visual, audio or haptic feedback when removing the information set from the graphical user interface.

6. An apparatus according to claim 1, wherein the at least one memory stores program instructions that, when executed by the at least one processing unit, cause the apparatus to:
remove the information set from the graphical user interface when detecting that the applied pressure level becomes zero.

7. An apparatus according to claim 1, wherein the graphical user interface element comprises at least one information icon indicating at least one new event detected by the apparatus.

8. An apparatus according to claim 1, wherein the graphical user interface element comprises a message provided by a messaging application.

9. An apparatus according to claim 1, wherein the information set comprises map data.

10. An apparatus according to claim 9, wherein the amount of map data provided in the information set is proportional to the pressure level applied on the pressure level sensitive user input device.

11. A method, comprising:
detecting that a pressure level applied on a pressure level sensitive user input device on a graphical user interface element of a graphical user interface exceeds a predetermined pressure level;
providing an information set relating to the graphical user interface element on the graphical user interface while the applied pressure level exceeds the predetermined pressure level;
detecting that the applied pressure level becomes lower than the predetermined pressure level; and
removing the information set from the graphical user interface.

12. A method according to claim 11, further comprising:
detecting that the pressure level applied on the pressure level sensitive user input device on the graphical user interface element on the graphical user interface exceeds a predetermined second pressure level, the predetermined second pressure level exceeding the predetermined first pressure level; and
extending the amount of information in the information set.

13. A method according to claim 11, wherein the amount of information provided in the information set is proportional to the pressure level applied on the pressure level sensitive user input device.

14. A method according to claim 11, further comprising:
providing at least one of visual, audio or haptic feedback when providing the information set relating to the graphical user interface element on the graphical user interface.

15. A method according to claim 11, further comprising:
providing at least one of visual, audio or haptic feedback when removing the information set from the graphical user interface.

16. A method according to claim 11, further comprising:
removing the information set from the graphical user interface when detecting that the applied pressure level becomes zero.

17. A method according to claim 11, wherein the graphical user interface element comprises at least one information icon indicating at least one new event detected by the apparatus.

18. A method according to claim 11, wherein the graphical user interface element comprises a message provided by a messaging application.

19. A method according to claim 11, wherein the information set comprises map data, and the amount of map data provided in the information set is proportional to the pressure level applied on the pressure level sensitive user input device.

20. An apparatus, comprising:
at least one processing unit;
at least one memory;
a touch and pressure level sensitive display element;
wherein the at least one memory stores program instructions that, when executed by the at least one processing unit, cause the apparatus to:
detect that a pressure level applied on a graphical user interface element on the touch and pressure level sensitive display element exceeds a predetermined pressure level;
provide an information set relating to the graphical user interface element on the touch and pressure level sensitive display element while the applied pressure level exceeds the predetermined pressure level;
detect that the applied pressure level becomes lower than the predetermined pressure level; and
remove the information set from the touch and pressure level sensitive display element.
